(19) United States
(12) Patent Application Publication
(10) Pub. No.: US 2026/0059448 A1
(43) Pub. Date: Feb. 26, 2026

(54) USE OF LP-RS FOR RRM MEASUREMENTS IN RRC CONNECTED STATE

(71) Applicant: QUALCOMM Incorporated, San Diego, CA (US)

(72) Inventors: Linhai HE, San Diego, CA (US); Yuchul KIM, San Diego, CA (US); Ahmed ELSHAFIE, San Diego, CA (US); Zhikun WU, Beijing (CN)

(21) Appl. No.: 19/102,815

(22) PCT Filed: Sep. 6, 2023
(86) PCT No.: PCT/CN2023/117208

§ 371 Date: Feb. 10, 2025

(30) Foreign Application Priority Data
Sep. 24, 2022 (WO) PCT/CN2022/121133

(51) Int. Cl. H04W 52/02; H04W 36/00

(52) U.S. Cl. CPC H04W 52/0235; H04W 36/0085

(57) ABSTRACT

A method of wireless communication at a UE includes communicating with a serving cell using a first receiver and performing one or more measurements in an RRC connected mode on a LP-RS using a second receiver having a lower power consumption than the first receiver. A method of wireless communication at a network node includes configure a LP-RS configuration for a UE for one or more measurements in an RRC connected mode with a second receiver at the UE having a lower power consumption than a first receiver at the UE; and transmit the LP-RS.

### CROSS REFERENCE TO RELATED APPLICATION

This application claims the benefit of and priority to International Application No. PCT/CN2022/121133, entitled “USE OF LP-RS FOR RRM MEASUREMENTS IN RRC CONNECTED STATE” and filed on Sep. 24, 2022, which is expressly incorporated by reference herein in its entirety.

### TECHNICAL FIELD

The present disclosure relates generally to communication systems, and more particularly, to wireless communication including signal strength measurement.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus is configured to communicate with a serving cell using a first receiver and perform one or more measurements in an RRC connected mode on a low-power reference signal (LP-RS) using a second receiver having a lower power consumption than the first receiver.

In an aspect of the disclosure, a method, a computer-readable medium, and an apparatus are provided for wireless communication at a network node. The apparatus is configured to configure a LP-RS configuration for a UE for one or more measurements in an RRC connected mode with a second receiver at the UE having a lower power consumption than a first receiver at the UE and transmit the LP-RS.

To the accomplishment of the foregoing and related ends, the one or more aspects comprise the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first subframe within a 5G NR frame structure.

FIG. 2B is a diagram illustrating an example of DL channels within a 5G NR subframe.

FIG. 2C is a diagram illustrating an example of a second subframe within a 5G NR frame structure.

FIG. 2D is a diagram illustrating an example of UL channels within a 5G NR subframe.

FIG. 3 is a block diagram of a base station in communication with a UE 350 in an access network.

FIG. 4 is a call flow diagram illustrating a UE, such as a UE in an RRC connected state, utilizing a first high-power (HP) radio for communicating with at least base station while utilizing a second low-power (LP) radio for performing RS measurements over a set of LP-RS in accordance with some aspects of the disclosure.

FIG. 5A is a diagram illustrating an example of a measurement gap between communication and measurement of a reference signal.

FIG. 5B is a diagram illustrating a set of SSBs and a set of corresponding LP-RSs whose location in time and frequency may be identified based on the location of the corresponding SSBs.

FIG. 6 is a diagram illustrating a set of LP-RS resources that overlap in time with communication resources in accordance with some aspects of the disclosure.

FIG. 7 is a flowchart of a method of wireless communication.

FIG. 8 is a flowchart of a method of wireless communication.

FIG. 9 is a flowchart of a method of wireless communication.

FIG. 10 is a flowchart of a method of wireless communication.

FIG. 11 is a diagram illustrating an example of a hardware implementation for an apparatus.

FIG. 12 is a diagram illustrating an example of a hardware implementation for a network entity.

### DETAILED DESCRIPTION

A UE may be equipped with a first, or main, radio and/or receiver (e.g., for communication and RS measurement) and a second, low-power radio and/or receiver (e.g., which may be referred to as a low-power wake up radio (LP-WUR) or by another name) that utilizes less power than the first receiver and/or radio of the UE. In some aspects, a UE may use the second radio and/or receiver (e.g., the LP-WUR) to monitor for, or receive and measure, an LP-RS. Aspects presented herein enable the UE to utilize a LP-WUR (e.g., as an example of a second, low-power radio and/or receiver) in different contexts (e.g., for measurement in an RRC connected state) in order to reduce UE power consumption and allow RS measurement via the LP-WUR without interrupting communication via the first, or main, receiver and/or radio. While the term LP-WUR may be used below for simplicity, the features and uses of the LP-WUR are to be understood to be applicable generally to second, low-power radios and/or receivers that utilize less power than a main radio and/or receiver. The aspects presented herein provide greater efficiency at the UE and help to reduce power consumption and/or extend battery life at the UE.

Aspects presented herein help to reduce UE power consumption and provide enhancements to RS measurement procedures using a LP-RS. In an example, a UE performs measurements (e.g., layer 3 reference signal received power (L3-RSRP) or layer 1 RSRP (L1-RSRP) measurements) on at least one LP-RS for one or more of radio resource management (RRM), radio link monitoring (RLM), beam failure detection (BFD), or random access channel (RACH) occasion selection. The at least one LP-RS may be associated with a serving cell and/or a neighboring cell. Thus, the UE may utilize the LP-RS for cell selection/reselection purposes without continually measuring SSBs. As measuring the LP-RS may consume less UE power than measuring an SSB, the UE power consumption may be reduced. For example, a UE may use a lower power radio rather than a main radio to obtain the measurements of the LP-RS. According to some configurations presented herein, the UE may utilize the LP-RS for additional purposes.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

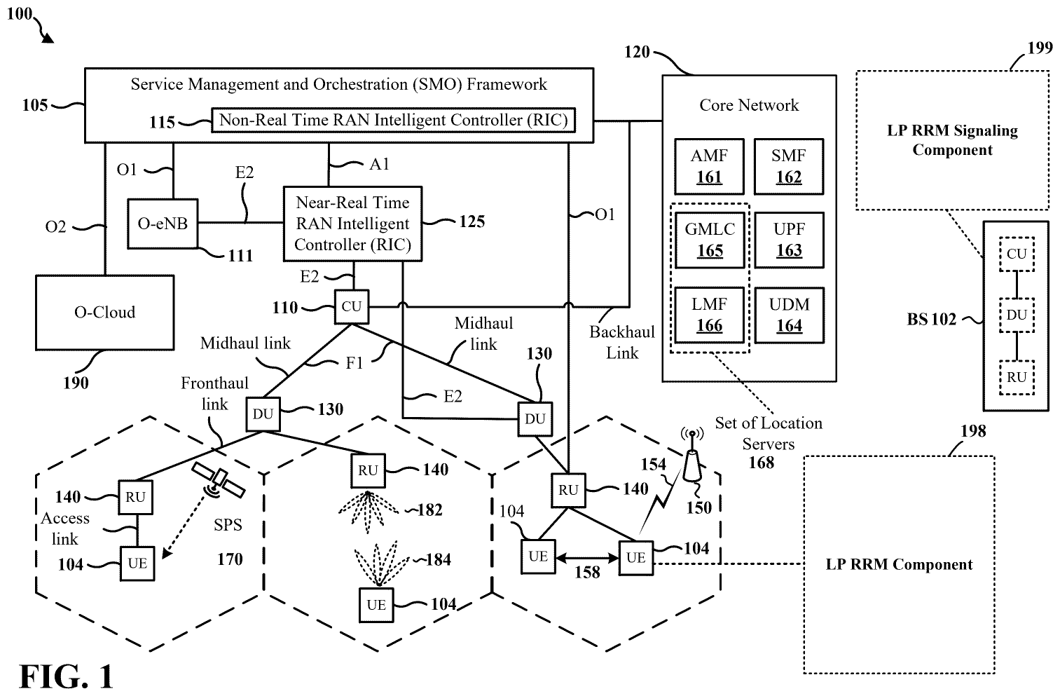

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHz), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include a LP RRM component 198 that is configured to communicate with a serving cell using a first receiver and perform one or more measurements in an RRC connected mode on a LP-RS using a second receiver having a lower power consumption than the first receiver. In certain aspects, the base station 102 include a LP RRM signaling component 199 that is configured to configure a LP-RS configuration for a UE for one or more measurements in an RRC connected mode with a second receiver at the UE having a lower power consumption than a first receiver at the UE and transmit the LP-RS. Although the following description may be focused on 5G NR, the concepts described herein may be applicable to other similar areas, such as LTE, LTE-A, CDMA, GSM, and other wireless technologies.

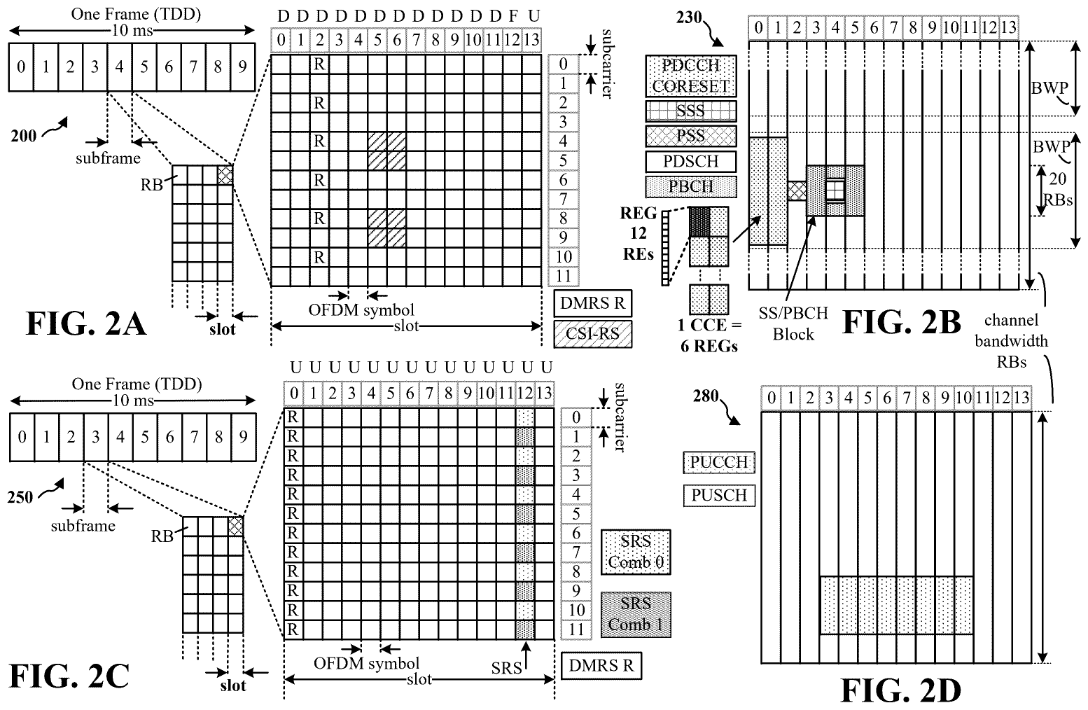

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology p, there are 14 symbols/slot and 2 slots/subframe. The subcarrier spacing may be equal to 2*15 kHz, where y is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology p=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

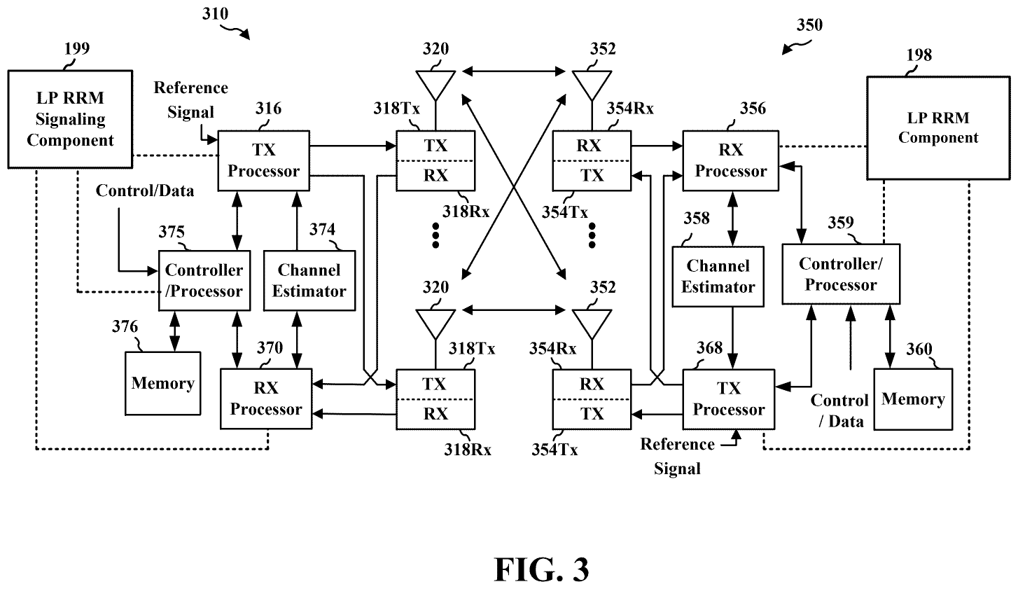

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antennas 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the LP RRM component 198 of FIG. 1.

At least one of the TX processor 316, the RX processor 370, and the controller/processor 375 may be configured to perform aspects in connection with the LP RRM signaling component 199 of FIG. 1.

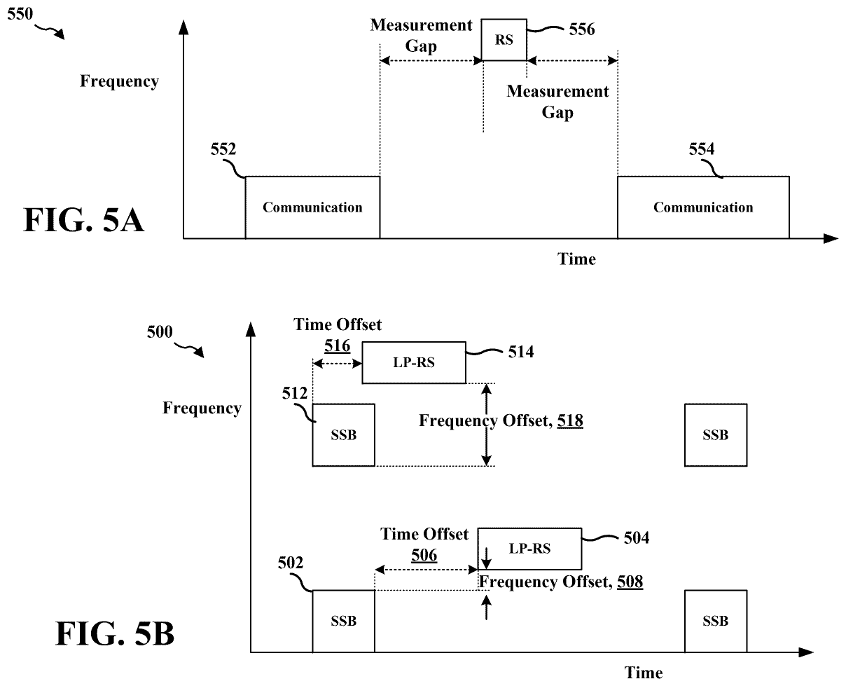

A UE may perform various measurements while the UE is in an RRC connected state. For example, the UE may measure one or more reference signals (RSs) received from a base station. In the RRC connected state, the measurements, e.g., RS measurements, may consume UE power. Additionally, the UE may perform such measurements using measurement gaps (e.g., gaps in time between communication and measurement performed by a same receiver). For example, a UE may use a receiver to perform RRM (or other) measurements on a frequency different from its serving cell frequency that the UE uses for a data communication. The UE may implement measurement gaps in the data communication to measure the RS transmitted by the base station, e.g., the measurement of the RS via a different frequency than the frequency used for transmitting or receiving data communication with the base station. FIG. 5A illustrates an example diagram 550 showing data communication 552 and 554 that are separated by a time gap (e.g., which may be referred to as a measurement gap) from a reference signal 556 that the UE measures, e.g., for RRM or other types of measurements. A measurement gap, in some aspects, may be a time period during which a UE tunes its operating frequency from the frequency for the data communication to the frequency associated with the RS measurement and performs one or more measurements on the reference signals (e.g., for inter-frequency RS measurements). During a measurement gap, a UE may interrupt its regular data Tx/Rx operations. For this reason, implementing measurement gaps consumes time resources that could be used for communication and may reduce UE throughput.

In some configurations, a UE may be equipped with a second, low-power radio and/or receiver (e.g., the LP-WUR) that utilizes less power than a first receiver and/or radio of the UE (e.g., which may be referred to as a main receiver or main radio). The LP-WUR may have a lower complexity than the main radio. In some aspects, the LP-WUR may be separate from the main radio, and may include a set of components that use less power than those comprised in the main radio. In other aspects, the LP-WUR may comprise a subset of components of the main radio. In an example, the LP-WUR may utilize less than 1 mA. In some aspects, the LP-WUR may be configured to receive a low-power wakeup signal (LP-WUS) or a LP-RS. The LP-WUS or LP-RS may use a simplified communication scheme in comparison to a WUS or RS that is received by the higher power radio/receiver. As an example, the LP-WUS or LP-RS may utilize an on off keying (OOK) modulation scheme. The OOK modulation scheme may limit a payload size of a LP-WUS.

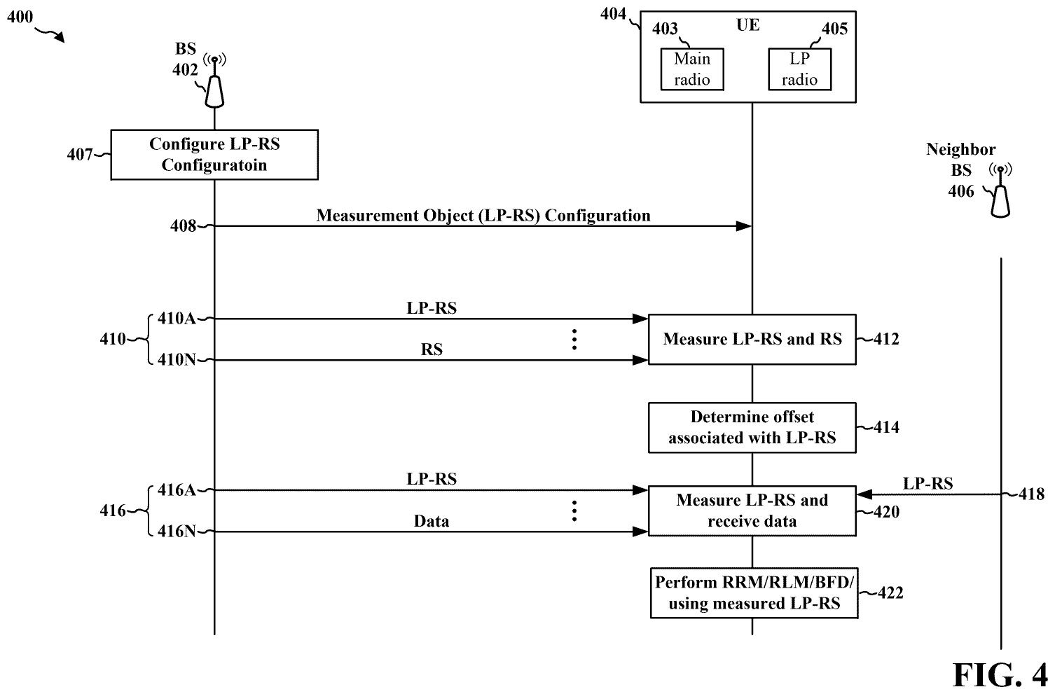

In some aspects, a UE may use a LP-WUR capable of using LP-RS for RS measurements. In some aspects, the LP-WUR may be used to perform inter-frequency RS measurement at the same time as a main radio, e.g., overlapping in time with communication or measurements on the main radio. In some aspects, the main radio or receiver is used to receive data communications. FIG. 4 is a call flow diagram 400 illustrating a UE 404, such as a UE in an RRC connected state, utilizing a first higher-power (HP) radio 403 for communicating with at least base station 402 and utilizing a second low-power (LP) radio 405 for performing RS measurements over a set of LP-RS in accordance with some aspects of the disclosure. The term “HP” may be used to refer to a radio with a power consumption that is higher than for the “LP” receiver. In some aspects, the HP receiver may be referred to as a higher power radio, a higher power receiver, a main radio, etc. At 407, the base station 402 may configure the UE to measure and/or report a LP-RS. The base station 402 may configure the UE to perform one or more measurements on the LP-RS (e.g., a RSRP, a reference signal received quality (RSRQ), or a signal to interference-and-noise ratio (SINR) measurement for neighbor cells, a serving cell, RRM, RLM, BFD, random access occasion (RO) selection, inter-frequency measurements, etc.

The base station 402, in some aspects, may transmit, and UE 404 may receive, a measurement object configuration 408. The measurement object configuration 408 may include an indication of the LP-RS configuration configured at 407. In some aspects, the measurement object may be configured in an RRC IE, such as a measurement configuration IE (which may be referred to as “measConfig IE” in some aspects). In some aspects, the measurement object may be for a serving cell measurement object (e.g., which may be referred to as a “ServingCellMO IE”). A presence of the measurement object for the LP-RS for a target frequency may indicate for the UE to perform the measurements on the LP-RS instead of a RS using the main radio, e.g., such as an SSB. For example, if the configuration for the LP-RS measurement object is not include in the RRC configuration, the UE may understand to measure the SSB using the main radio. If an RRC configuration includes the measurement object for the LP-RS for a target frequency, the UE may instead measure the LP-RS using the LP radio for that target frequency. The UE may ignore measurement gaps configured for the frequency, e.g., and may perform the measurements on the LP-RS using the LP radio without a measurement gap between communication using the main radio.

The manner in which the LP-RS for serving cell measurements is configured may depend on the UE's BWP configuration. As an example, if none of the BWPs configured for the UE contains an SSB, the base station 402 may configure an LP-RS field in a ServingCellMO IE, e.g., under a serving cell configuration (e.g., which may be referred to as “ServingCellConfig IE”). In some aspects, the base station 402 may configure a BWP-specific serving cell measurement object (e.g., a “ServingCellMO IE”) under a dedicated BWP (e.g., which may be referred to as “BWP-DownlinkDedicated IE”). As an example, in the BWP-specific ServingCellMO IE, the base station 402 may configure a new LP-RS field in the ServingCellMO IE. In some aspects, the LP-RS field in the configured measurement object may include time and frequency information (e.g., a time location of the LP-RS based on the SSB defined for that frequency, e.g., a periodicity of the LP-RS and a time offset with respect to the first transmission occasion of SSB after SFN=1). The LP-RS field may also indicate a frequency location of the LP-RS based on an offset with respect to the target frequency. The measurement object may include a measurement offset for UE to translate the RSRP/RSRQ measurements on LP-RS to equivalent RSRP/RSRQ measurements if taken on the SSB configured on that frequency.

The LP-RS configuration, in some aspects, may include an indication of a location in time and/or frequency of one or more LP-RSs for the UE to measure. The indication of the location, in some aspects, may be relative to a (known) location in time and/or frequency of an SSB. In some aspects, a periodicity of the LP-RS and a time offset may be configured for the UE with respect to a particular transmission occasion of an SSB, such as a first transmission occasion of the SSB after SFN=1. The frequency location of the LP-RS may be configured by an offset with respect to a target frequency, for example. FIG. 5B is a diagram 500 illustrating a set of SSBs and a set of corresponding LP-RSs whose location in time and frequency may be identified based on the location of the corresponding SSBs. For example, a first SSB 502 may be used to identify the location in time and frequency of a corresponding LP-RS 504 based on the location of the first SSB 502 and (1) a time offset 506 indicating a time between the end of the first SSB 502 and the beginning and of the LP-RS 504 and (2) a frequency offset 508 indicating a frequency gap between a highest frequency associated with the first SSB 502 and the lowest frequency associated with the LP-RS 504. Additionally, a second SSB 512 may be used to identify the location in time and frequency of a corresponding LP-RS 514 based on the location of the second SSB 512 and (1) a time offset 516 indicating a time between the beginning of the second SSB 512 and the beginning and of the LP-RS 514 and (2) a frequency offset 518 indicating a frequency gap between a lowest frequency associated with the second SSB 512 and the lowest frequency associated with the LP-RS 514.

The LP-RS configuration, in some aspects, may include an indication of a location in time and/or frequency of one or more LP-RSs in a BWP that does not include an SSB (or other high-power RS). For example, in some aspects, a BWP may be configured for a UE that does not include an SSB. As an example, a reduced capability UE may be configured with an active BWP that does not include an SSB. The measurement object configuration 408, for such a LP-RS, in some aspects, may be a serving cell measurement object configuration or a BWP-specific measurement object configuration. The LP-RS configuration, in some aspects, may include at least one of a time location of the LP-RS, a frequency location of the LP-RS, and a measurement offset for the LP-RS. In some aspects, the time location of the LP-RS may be indicated relative to an SSB for a particular frequency, the frequency location of the LP-RS may be indicated relative to a target frequency, and the measurement offset for the LP-RS may be indicated relative to an SSB measurement, e.g., for a particular SSB or set of SSBs or for a particular frequency or set of frequencies.

The indication of the location in time and/or frequency of the LP-RS, in some aspects, may indicate a location associated with one or more of a BWP or a secondary cell group (SCG). In some aspects, the BWP may be a dormant BWP and/or the SCG may be a deactivated SCG. The indication of the location in time and/or frequency in the dormant BWP and/or the SCG may further indicate for the UE to use the LP radio 405 to measure the LP-RS instead of using the HP radio 403 to measure a corresponding SSB (or another high-power RS such as a CSI-RS).

To perform serving cell measurements, UE may check whether a LP-RS field is present in a serving cell measurement object information element (e.g., which may be referred to as a “ServingCellMO IE”) or a bandwidth part specific serving cell measurement objection (e.g., which may be referred to as a “BWP-specific ServingCellMO”) for an active BWP.

In either of these two cases, UE may use the configured LP-RS instead of an SSB to perform serving cell measurements. For example, the UE may perform the measurements of the LP-RS using an LP-WUR. In some aspects, measurements gaps are not followed. If both the ServingCellMO IE and BWP-specific ServingCellMO for the active BWP include a LP-RS field, the one in the BWP-specific ServingCellMO may overrides the LP-RS indication in the ServingCellMO IE. For example, if the LP-RS field is included in both measurement objects, the UE may use the LP-RS field from the BWP specific serving cell measurement object and disregard the LP-RS field in the serving cell measurement object. If the LP-RS field is included in only one of the measurement objects, the UE may perform the measurements using the indicated LP-RS field. If the LP-RS field is not included in either of the measurement objects, the UE may perform the serving cell measurements using the SSB configured in the ServingCellMO IE, e.g., rather than an LP-RS.

In some aspects, the measurement object configuration 408 may include an offset for at least one threshold associated with one or more measurements on the LP-RS (e.g., a RSRP, a reference signal received quality (RSRQ), or a signal to interference-and-noise ratio (SINR)) relative to a measurement on a RS with the main radio, such as an SSB or CSI-RS. The threshold may be for RRM measurements, serving cell measurements, RLM, BFD, random access occasion (RO) selection, etc. The configured offset may be a semi-static offset between the two types of measurements, for example. The offset, in some aspects, may be an offset to use when comparing measurements made using the LP-RS via the LP radio 405 to measurements using other RSs (e.g., SSBs or CSI-RSs) via the HP radio 403 or to thresholds defined for the other RSs. In some aspects, the offset may be used for a RS (e.g., an SSB or a CSI-RS) in a same BWP as the LP-RS.

In some aspects, rather than receiving a configuration of the offset between measurement of the LP-RS and a RS using the main radio, the UE may obtain, determine, or identify a measurement offset between the LP-RS using the LP radio and the RS using the main radio. For example, the base station 402 may transmit, and the UE 404 may receive, a set of RS 410 including at least one LP-RS 410A and at least one additional RS 410N (e.g., a high-power RS such as an SSB or CSI-RS). In some aspects, the measurement of the reference signals using the two radios may be overlapping in time or simultaneous. The UE 404, in some aspects, may measure, at 412, the at least one LP-RS 410A and the at least one additional RS 410N. The UE 404 may determine, at 414, an offset (e.g., an RSRP offset, RSRQ offset, or SINR offset) associated with the LP-RS 410A and, in some aspects, LP-RSs generally. For example, if the measurement object configuration 408 does not include an offset, the UE 404 may measure, at 412, the LP-RS 410A and the RS 410N and determine, at 414, the offset associated with the RS measurement. In some aspects, the determination, at 414, may be based on an indication included in measurement object configuration 408.

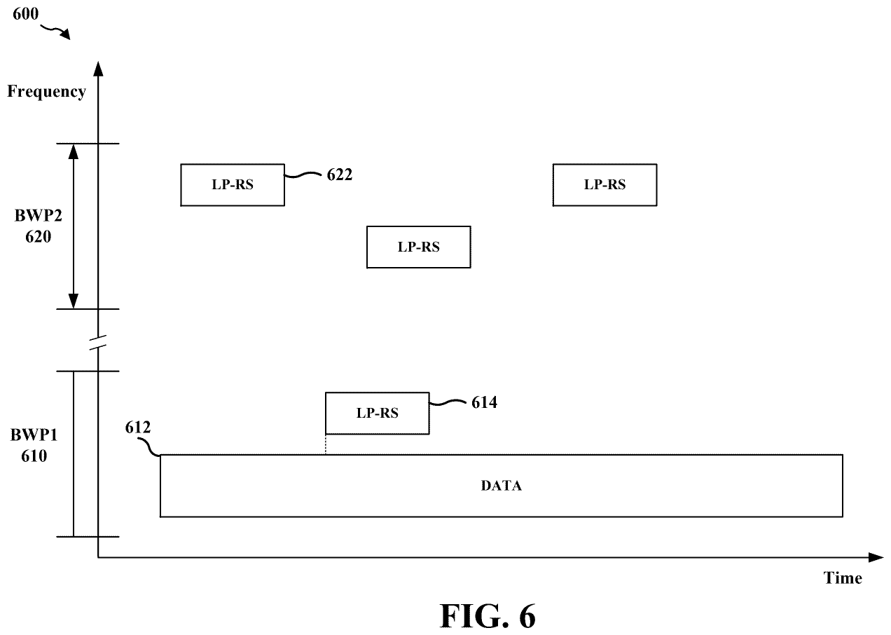

Based on the measurement object configuration 408, the base station 402 may transmit, and the UE 404 may receive, a set of transmissions 416. An additional (neighbor) base station 406 may transmit, and UE 404 may receive, a LP-RS 418. The set of transmissions 416, in some aspects, may include a LP-RS 416A and data 416N. The data 416N, in some aspects, may be transmitted via a first set of time resources that overlaps with time resources used to transmit at least one of the LP-RS 416A and/or the LP-RS 418. The UE 404, in some aspects, may measure, at 420, the LP-RS 416A and/or the LP-RS 418 using the LP radio 403 and may receive data using the main radio, e.g., HP radio 403. In some aspects, the communication with the main radio, e.g., HP radio 403, may overlap at least partially in time with the measurement of the LP-RS 416A via the LP radio 405. For example, the UE 404 may measure the LP-RS 416A via the LP radio 405 while receiving data 416N via the HP radio 403. In some aspects, measuring, at 420, the LP-RS may include deriving an equivalent measurement for a corresponding measurement of a different RS (e.g., an SSB or CSI-RS) using the offset received in measurement object configuration 408 or determined at 414. Based on the LP-RS measured at 420, the UE 404 may perform, at 422, one or more of RRM, RLM, BFD, or RACH occasion selection. FIG. 6 is a diagram 600 illustrating a set of LP-RS resources that overlap in time with communication resources in accordance with some aspects of the disclosure. For example, a first set of data transmission resources 612 may overlap in time (but not in frequency) with a LP-RS 614 in a same BWP as the first set of data transmissions (e.g., BWP 1 610) and/or LP-RS 622 in a different BWP from the first set of data transmissions (e.g., BWP 2 620).

As discussed above, the diagram 500 includes an SSB 502, an SSB 512, an LP-RS 504, and a LP-RS 514. The LP-RS may be structured such that a UE uses less power to receive the LP-RS than the SSB. The LP-RS may include a different waveform than the SSB and/or a different modulation than the SSB, the waveform or modulation of the LP-RS being received using less power than the waveform/modulation of the SSB. In some aspects, the waveform and/or modulation of the LP-RS may be the same as a waveform or modulation for a LP-WUS. As illustrated in FIG. 5B, the LP-RS 504 may span less frequency resources than the SSB 502. For example, the base station may transmit the LP-RS 504 in a narrower frequency band over a longer period of time than the SSB 502. In some aspects, the LP-RS 504 may include a defined sequence transmitted by a serving cell. The defined sequence of the LP-RS 504 may be scrambled by a PCI, or a payload of the LP-RS may carry the PCI for cell identification.

The diagram 500 in FIG. 5B shows a location of the LP-RS 504 being defined based on a time offset 506 and a frequency offset 508 with respect to a synchronization raster (also referred to as a sync raster). The synchronization raster defines known locations of transmission locations of SSBs. Through use of the synchronization raster, the UE knows locations of the SSBs. As the UE knows a time and frequency location of the SSB 502 through the synchronization raster, the UE may determine, or know, a time and frequency location of the LP-RS 504. The base station may transmit LP-RSs with a periodicity that is longer than a periodicity of SSBs due to RRM measurements being performed in idle mode DRX or extended DRX. For instance, the UE may not need to measure LP-RSs at the same rate as SSBs, which are typically transmitted every 20 ms. Through use of repetitions, the LP-RS 504 may have similar or the same coverage as the SSB 502. The base station may configure a number of repetitions of LP-RSs. In one aspect, the UE may determine a time and frequency location of the SSB 502 based on the sync raster. The UE may determine a location of the LP-RS 504 based on the time and frequency location of the SSB 502.

Aspects presented herein provide measurement procedures with power savings and increased efficiency in the use of time resources through use of an LP-RS. In an RRC Connected state, data related procedures (e.g., transmitting, receiving, and PDCCH monitoring) may consume much of the UE's power. In some aspects, the power savings from a measurement procedure using an LP-RS may be low compared to the total power consumed by data related procedures at the UE (e.g. transmission of data, receiving data, monitoring for control signaling associated with data).

Aspects provided herein enable use of an LP-RS in situations that may provide power saving benefits. For example, a UE can use a LP-WUR to perform inter-frequency RRM measurements, which can help to avoid the negative impact of measurement gaps on UE throughput, e.g., by performing the measurements without a measurement gap time period during which UE tunes its operating frequency to the target frequency and perform measurements on the reference signals on that frequency (e.g., inter-frequency measurements). The use of the LP radio to measure the LP-RS avoids a measurement gap during which the UE interrupts its data Tx/Rx operations and reduces the impact of the inter-frequency measurements on UE throughput. This may allow the UE to perform inter-frequency measurements at the same time as performing regular data transmission so that there is no loss in throughput while the UE performs the measurements with the LP radio.

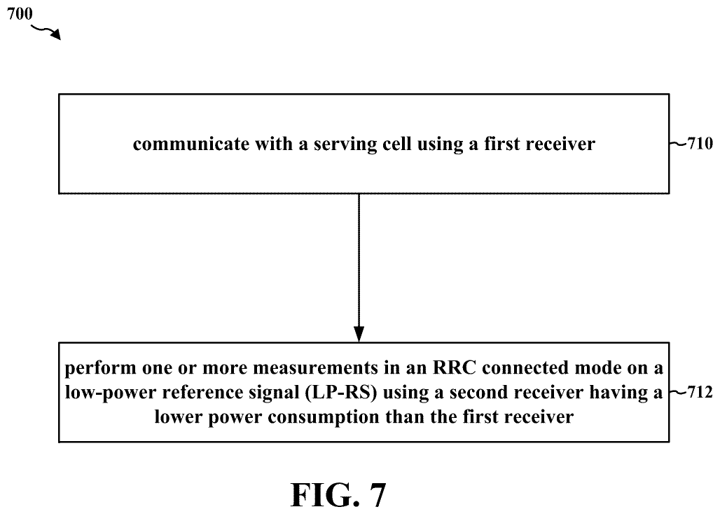

FIG. 7 is a flowchart 700 of a method of wireless communication. The method may be performed by a UE (e.g., the UE 104, the UE 350, the UE 404, the apparatus 1104). In an example, the method (including the various configurations described below) may be performed by the LP RRM component 198. The method may be associated with various advantages for the UE, such as reduced UE power consumption and increased data throughput.

The UE may receive a measurement object configuration indicating a LP-RS configuration. In some aspects, the LP-RS configuration indicates a location in at least one of time or frequency of the LP-RS relative to an SSB. For example, referring to FIG. 4, the UE 404 may receive, and the base station 402 may transmit, the measurement object configuration 408. The UE may receive, as part of receiving the measurement object configuration 408, the LP-RS configuration of an offset for at least one threshold associated with one or more measurements on the LP-RS (e.g., a RSRP, a RSRQ, or a SINR). The offset, in some aspects, may be an offset to use when comparing measurements made using the LP-RS via the second receiver to measurements using other RSs (e.g., SSBs or CSI-RSs) via the first receiver or to thresholds defined for the other RSs. In some aspects, the offset may be used for a RS (e.g., an SSB or a CSI-RS) in a same BWP as the LP-RS.

The UE may receive, as part of receiving the measurement object configuration, an indication of a location in time and/or frequency of one or more LP-RSs in a BWP that does not include an SSB (or another higher-power RS). The measurement object configuration, for such a LP-RS, in some aspects, may be a serving cell measurement object configuration or a BWP-specific measurement object configuration. The LP-RS configuration, in some aspects, may include at least one of a time location of the LP-RS, a frequency location of the LP-RS, and a measurement offset for the LP-RS. In some aspects, the time location of the LP-RS may be indicated relative to an SSB for a particular frequency, the frequency location of the LP-RS may be indicated relative to a target frequency, and the measurement offset for the LP-RS may be indicated relative to an SSB measurement, e.g., for a particular SSB or set of SSBs or for a particular frequency or set of frequencies.

The indication of the location in time and/or frequency of the LP-RS, in some aspects, may indicate a location associated with one or more of a BWP or a SCG. In some aspects, the BWP may be a dormant BWP and/or the SCG may be a deactivated SCG. The indication of the location in time and/or frequency in the dormant BWP and/or the SCG may further indicate for the UE to use a second receiver having a lower power consumption than the first receiver to measure the LP-RS instead of using the first receiver to measure a corresponding SSB (or another higher-power RS such as a CSI-RS).

The UE may determine an offset between the LP-RS measured at the second receiver and a corresponding reference signal measured at the first receiver. Determining the offset, in some aspects, may be performed periodically, e.g., on each of a set of periodic RSs and related LP-RSs. For example, referring to FIG. 4, the UE 404 may determine, at 414, the offset associated with the LP-RS. In some aspects, determining the offset may be based on an indication for the UE to determine the offset included in the measurement object configuration.

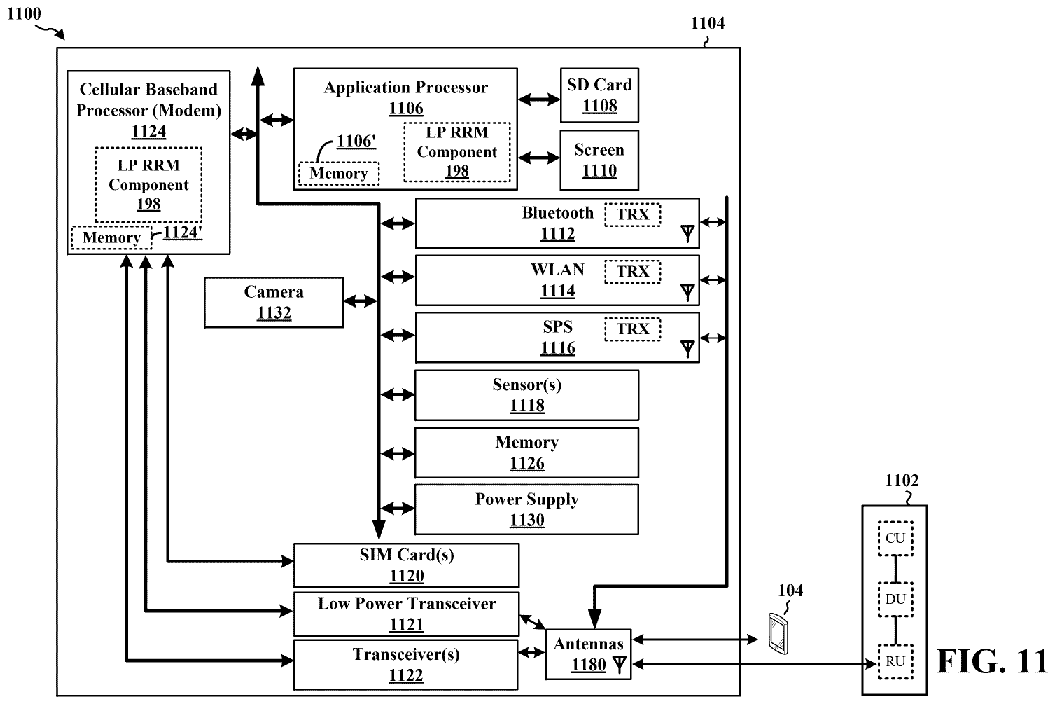

At 710, the UE may communicate with a serving cell using a first receiver. For example, 710 may be performed by application processor 1106, cellular baseband processor 1124, transceiver(s) 1122, antenna(s) 1180, and/or LP RRM component 198 of FIG. 11. Referring to FIG. 4, for example, the UE 404 may receive, at 420, transmitted data 416N.

At 712, the UE may perform one or more measurements in an RRC connected mode on a LP-RS using a second receiver having a lower power consumption than the first receiver. For example, 712 may be performed by application processor 1106, cellular baseband processor 1124, transceiver(s) 1121, antenna(s) 1180, and/or LP RRM component 198 of FIG. 11. In some aspects, communication with the first receiver at 710 may overlap in time with the one or more measurements with the second receiver. The UE, in some aspects, may be configured to perform the one or more measurements on the LP-RS instead of a reference signal measured with the first receiver based on a presence of the LP-RS configuration in the measurement object configuration received at 702. The one or more measurements, in some aspects, may include an RRM measurement of a serving cell or one or more neighbor cells. In some aspects, the one or more measurements may include an inter-frequency measurement.

The one or more measurements, in some aspects, may include a serving cell measurement. In some aspects in which the one or more measurements include a serving cell measurement, the UE may be configured to receive a LP-RS configuration associated with a BWP that does not include an SSB. In some such aspects, the LP-RS may be included in at least one of a serving cell measurement object configuration or a BWP specific measurement object configuration. The LP-RS configuration associated with the BWP that does not include an SSB, in some aspects, may include at least one of: a time location of the LP-RS relative to the SSB for a particular frequency, a frequency location of the LP-RS relative to a target frequency, or a measurement offset for the LP-RS relative to an SSB measurement. The UE, in some aspects, may be configured to perform the one or more measurements at 712 on the LP-RS instead of the SSB based on a presence of the LP-RS configuration in the serving cell measurement object configuration or the BWP specific measurement object configuration.

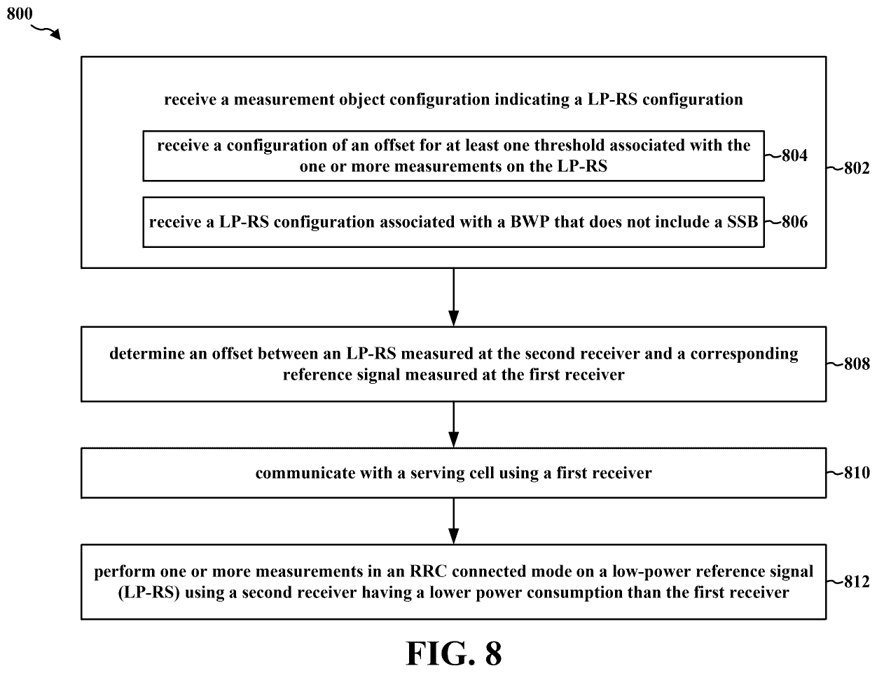

FIG. 8 is a flowchart 800 of a method of wireless communication. The method may be performed by a UE (e.g., the UE 104, the UE 350, the UE 404, the apparatus 1104). In an example, the method (including the various configurations described below) may be performed by the LP RRM component 198. The method may be associated with various advantages for the UE, such as reduced UE power consumption and increased data throughput.

At 802, the UE may receive a measurement object configuration indicating a LP-RS configuration. For example, 802 may be performed by application processor 1106, cellular baseband processor 1124, transceiver(s) 1122, antenna(s) 1180, and/or LP RRM component 198 of FIG. 11. In some aspects, the LP-RS configuration indicates a location in at least one of time or frequency of the LP-RS relative to an SSB. For example, referring to FIG. 4, the UE 404 may receive, and the base station 402 may transmit, the measurement object configuration 408.

At 804, the UE may receive, as part of receiving the measurement object configuration at 802, the LP-RS configuration of an offset (e.g., a threshold offset) associated with one or more measurements on the LP-RS (e.g., a RSRP, a RSRQ, or a SINR). For example, 804 may be performed by application processor 1106, cellular baseband processor 1124, transceiver(s) 1122, antenna(s) 1180, and/or LP RRM component 198 of FIG. 11. The offset, in some aspects, may be an offset to use when comparing measurements made using the LP-RS via the second receiver to measurements using other RSs (e.g., SSBs or CSI-RSs) via the first receiver or to thresholds defined for the other RSs. In some aspects, the offset may be used for a RS (e.g., an SSB or a CSI-RS) in a same BWP as the LP-RS.

At 806, the UE may receive, as part of receiving the measurement object configuration at 802, an indication of a location in time and/or frequency of one or more LP-RSs in a BWP that does not include an SSB (or another higher-power RS). For example, 806 may be performed by application processor 1106, cellular baseband processor 1124, transceiver(s) 1122, antenna(s) 1180, and/or LP RRM component 198 of FIG. 11. The measurement object configuration, for such a LP-RS, in some aspects, may be a serving cell measurement object configuration or a BWP-specific measurement object configuration. The LP-RS configuration, in some aspects, may include at least one of a time location of the LP-RS, a frequency location of the LP-RS, and a measurement offset for the LP-RS. In some aspects, the time location of the LP-RS may be indicated relative to an SSB for a particular frequency, the frequency location of the LP-RS may be indicated relative to a target frequency, and the measurement offset for the LP-RS may be indicated relative to an SSB measurement, e.g., for a particular SSB or set of SSBs or for a particular frequency or set of frequencies.

The indication of the location in time and/or frequency of the LP-RS, in some aspects, may indicate a location associated with one or more of a BWP or a SCG. In some aspects, the BWP may be a dormant BWP and/or the SCG may be a deactivated SCG. The indication of the location in time and/or frequency in the dormant BWP and/or the SCG may further indicate for the UE to use a second receiver having a lower power consumption than the first receiver to measure the LP-RS instead of using the first receiver to measure a corresponding SSB (or another higher-power RS such as a CSI-RS).

At 808, the UE may determine an offset between the LP-RS measured at the second receiver and a corresponding reference signal measured at the first receiver. For example, 808 may be performed by application processor 1106, cellular baseband processor 1124, and/or LP RRM component 198 of FIG. 11. Determining the offset at 808, in some aspects, may be performed periodically, e.g., on each of a set of periodic RSs and related LP-RSs. For example, referring to FIG. 4, the UE 404 may determine, at 414, the offset associated with the LP-RS. In some aspects, determining the offset at 808 may be based on an indication for the UE to determine the offset included in the measurement object configuration received at 802.

At 810, the UE may communicate with a serving cell using a first receiver. For example, 810 may be performed by application processor 1106, cellular baseband processor 1124, transceiver(s) 1122, antenna(s) 1180, and/or LP RRM component 198 of FIG. 11. Referring to FIG. 4, for example, the UE 404 may receive, at 420, a data transmission (e.g., data 416N).

At 812, the UE may perform one or more measurements in an RRC connected mode on a LP-RS using a second receiver having a lower power consumption than the first receiver. For example, 812 may be performed by application processor 1106, cellular baseband processor 1124, transceiver(s) 1121, antenna(s) 1180, and/or LP RRM component 198 of FIG. 11. In some aspects, communication with the first receiver at 810 may overlap in time with the one or more measurements with the second receiver. The UE, in some aspects, may be configured to perform the one or more measurements on the LP-RS instead of a reference signal measured with the first receiver based on a presence of the LP-RS configuration in the measurement object configuration received at 802. The one or more measurements, in some aspects, may include an RRM measurement of a serving cell or one or more neighbor cells. In some aspects, the one or more measurements may include an inter-frequency measurement.

The one or more measurements, in some aspects, may include a serving cell measurement. In some aspects in which the one or more measurements include a serving cell measurement, the UE may be configured to receive, at 802, a LP-RS configuration associated with a BWP that does not include an SSB. In some such aspects, the LP-RS may be included in at least one of a serving cell measurement object configuration or a BWP specific measurement object configuration. The LP-RS configuration associated with the BWP that does not include an SSB, in some aspects, may include at least one of: a time location of the LP-RS relative to the SSB for a particular frequency, a frequency location of the LP-RS relative to a target frequency, or a measurement offset for the LP-RS relative to an SSB measurement. The UE, in some aspects, may be configured to perform the one or more measurements at 812 on the LP-RS instead of the SSB based on a presence of the LP-RS configuration in the serving cell measurement object configuration or the BWP specific measurement object configuration.

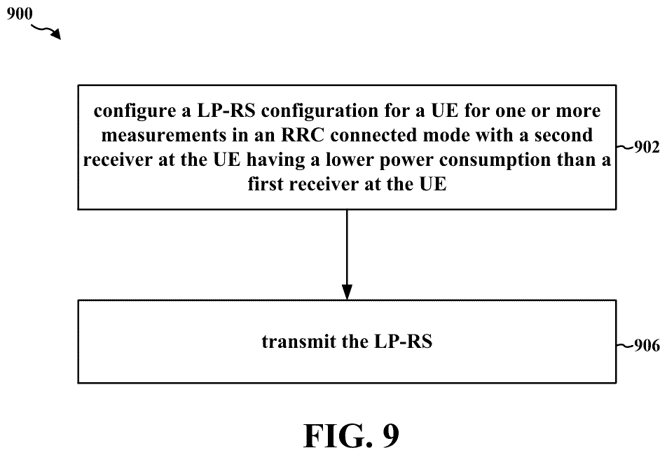

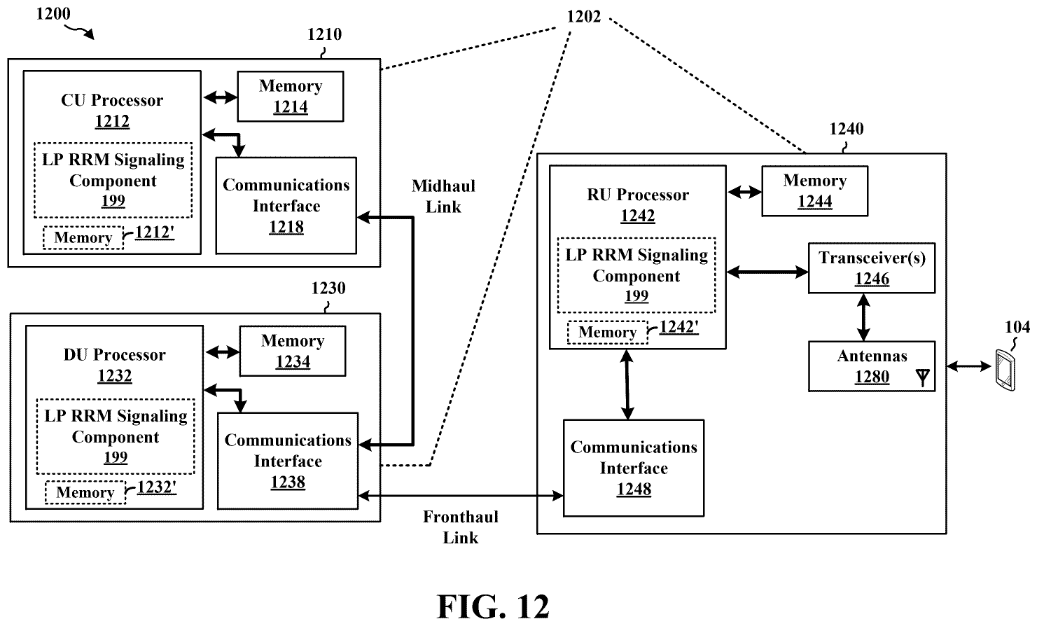

FIG. 9 is a flowchart 900 of a method of wireless communication. The method may be performed by a network node (e.g., the base station 102, the base station 310, the base station 402, the network entity 1102). In an example, the method (including the various configurations described below) may be performed by the LP RRM signaling component 199. At 902, the network node may configure an LP-RS configuration for a UE for one or more measurements in an RRC connected mode with a second receiver at the UE having a lower power consumption than a first receiver at the UE. For example, 902 may be performed by CU processor 1212, DU processor 1232, RU processor 1242, and/or LP RRM signaling component 199 of FIG. 12. The one or more measurements, in some aspects, may include an RRM measurement of a serving cell or one or more neighbor cells. In some aspects, the one or more measurements may include an inter-frequency measurement. The one or more measurements, in some aspects, may include a serving cell measurement. In some aspects, the LP-RS configuration configured at 902 may include at least one of: a time location of the LP-RS relative to an SSB for a particular frequency, a frequency location of the LP-RS relative to a target frequency, or a measurement offset for the LP-RS relative to an SSB measurement. For example, referring to FIG. 4, the base station 402 may configure the LP-RS configuration at 407. The network node may transmit, for the UE, an indication of the LP-RS configuration configured at 902. Referring to FIG. 4, the base station 402 may transmit measurement object configuration 408 indicating the LP-RS configuration configured at 407 by the base station 402.

Finally, at 906, the network node may transmit the LP-RS. For example, 906 may be performed by CU processor 1212, DU processor 1232, RU processor 1242, transceiver(s) 1246, antenna(s) 1280, and/or LP RRM signaling component 199 of FIG. 12. The LP-RS transmitted at 904, in some aspects, may be a LP-RS associated with the LP-RS configuration configured at 902. The LP-RS may be transmitted, at 906, via the time and/or frequency resources indicated in the LP-RS configuration transmitted at 904 (and configured at 902). For example, the LP-RS may be transmitted via the time location of the LP-RS relative to the SSB for the particular frequency and/or via the frequency location of the LP-RS relative to the target frequency. In some aspects, the LP-RS may comprise an OOK modulation scheme or an OFDMA modulation scheme that is one of the same modulation scheme as an SSB or a different modulation from an SSB. For example, referring to FIG. 4, the base station 402 may transmit LP-RS 410A or 416A.

The base station may transmit communication to the UE for reception with the first receiver. In some aspects, the communication overlaps in time with the LP-RS. The communication may be transmitted via a different frequency from the LP-RS such that the communication is received via a first receiver and the LP-RS is received via a second receiver having a lower power consumption than the first receiver at the UE. For example, referring to FIG. 4, the base station 402 may transmit data 416N.

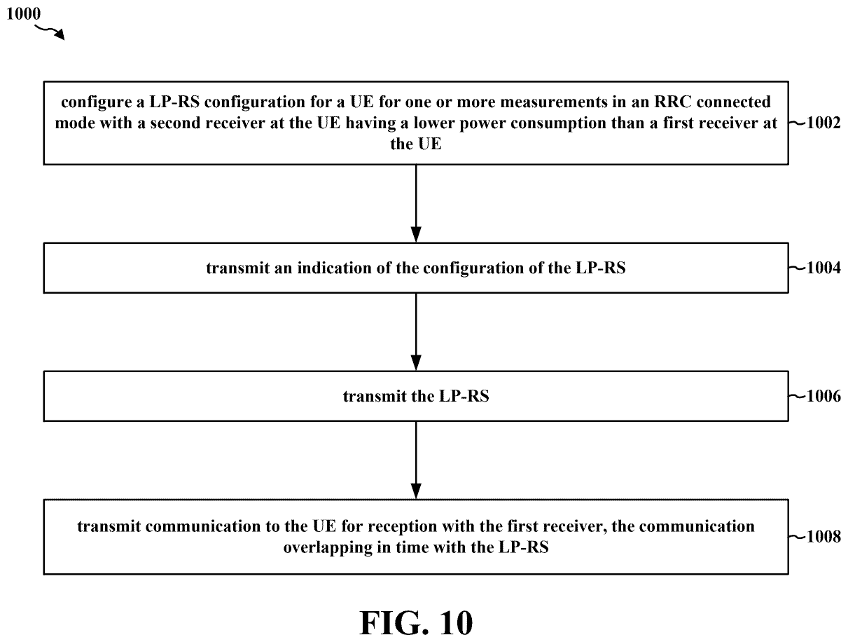

FIG. 10 is a flowchart 1000 of a method of wireless communication. The method may be performed by a network node (e.g., the base station 102, the base station 310, the base station 402, the network entity 1102). In an example, the method (including the various configurations described below) may be performed by the LP RRM signaling component 199. At 1002, the network node may configure an LP-RS configuration for a UE for one or more measurements in an RRC connected mode with a second receiver at the UE having a lower power consumption than a first receiver at the UE. For example, 1002 may be performed by CU processor 1212, DU processor 1232, RU processor 1242, and/or LP RRM signaling component 199 of FIG. 12. The one or more measurements, in some aspects, may include an RRM measurement of a serving cell or one or more neighbor cells. In some aspects, the one or more measurements may include an inter-frequency measurement. The one or more measurements, in some aspects, may include a serving cell measurement. In some aspects, the LP-RS configuration configured at 1002 may include at least one of: a time location of the LP-RS relative to an SSB for a particular frequency, a frequency location of the LP-RS relative to a target frequency, or a measurement offset for the LP-RS relative to an SSB measurement. For example, referring to FIG. 4, the base station 402 may configure the LP-RS configuration at 407.

At 1004, the network node may transmit, for the UE, an indication of the LP-RS configuration configured at 1002. For example, 1004 may be performed by CU processor 1212, DU processor 1232, RU processor 1242, transceiver(s) 1246, antenna(s) 1280, and/or LP RRM signaling component 199 of FIG. 12. Referring to FIG. 4, the base station 402 may transmit measurement object configuration 408 indicating the LP-RS configuration configured at 407 by the base station 402.

At 1006, the network node may transmit the LP-RS. For example, 1006 may be performed by CU processor 1212, DU processor 1232, RU processor 1242, transceiver(s) 1246, antenna(s) 1280, and/or LP RRM signaling component 199 of FIG. 12. The LP-RS transmitted at 1004, in some aspects, may be a LP-RS associated with the LP-RS configuration configured at 1002. The LP-RS may be transmitted, at 1006, via the time and/or frequency resources indicated in the LP-RS configuration transmitted at 1004 (and configured at 1002). For example, the LP-RS may be transmitted via the time location of the LP-RS relative to the SSB for the particular frequency and/or via the frequency location of the LP-RS relative to the target frequency. In some aspects, the LP-RS may comprise an OOK modulation scheme or an OFDMA modulation scheme that is one of the same modulation scheme as an SSB or a different modulation from an SSB. For example, referring to FIG. 4, the base station 402 may transmit LP-RS 410A or 416A.

Finally, at 1008, the base station may transmit communication to the UE for reception with the first receiver. In some aspects, the communication overlaps in time with the LP-RS. For example, 1008 may be performed by CU processor 1212, DU processor 1232, RU processor 1242, transceiver(s) 1246, antenna(s) 1280, and/or LP RRM signaling component 199 of FIG. 12. The communication may be transmitted via a different frequency from the LP-RS such that the communication is received via a first receiver and the LP-RS is received via a second receiver having a lower power consumption than the first receiver at the UE. For example, referring to FIG. 4, the base station 402 may transmit data 416N.

FIG. 11 is a diagram 1100 illustrating an example of a hardware implementation for an apparatus 1104. The apparatus 1104 may be a UE, a component of a UE, or may implement UE functionality. In some aspects, the apparatus 1104 may include at least one cellular baseband processor 1124 (also referred to as a modem) coupled to one or more transceivers 1122 (e.g., cellular RF transceiver). The cellular baseband processor(s) 1124 may include at least one on-chip memory 1124′. In some aspects, the apparatus 1104 may further include one or more subscriber identity modules (SIM) cards 1120 and at least one application processor 1106 coupled to a secure digital (SD) card 1108 and a screen 1110. The application processor 1106 may include on-chip memory 1106′. In some aspects, the apparatus 1104 may further include a Bluetooth module 1112, a WLAN module 1114, an SPS module 1116 (e.g., GNSS module), one or more sensor modules 1118 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1126, a power supply 1130, and/or a camera 1132. The Bluetooth module 1112, the WLAN module 1114, and the SPS module 1116 may include an on-chip transceiver (TRX) (or in some cases, just a receiver (RX)). The Bluetooth module 1112, the WLAN module 1114, and the SPS module 1116 may include their own dedicated antennas and/or utilize one or more antennas 1180 for communication. The cellular baseband processor 1124 communicates through the transceiver(s) 1121 and 1122 via the one or more antennas 1180 with the UE 104 and/or with an RU associated with a network entity 1102. For example, as described in connection with FIG. 4, the apparatus may include a low power transceiver 1121 that uses less power than the transceiver(s) 1122. The cellular baseband processor(s) 1124 and the application processor(s) 1106 may each include a computer-readable medium/memory 1124′, 1106′, respectively. The additional memory modules 1126 may also be considered a computer-readable medium/memory. Each computer-readable medium/memory 1124′, 1106′, 1126 may be non-transitory. The cellular baseband processor(s) 1124 and the application processor(s) 1106 are each responsible for general processing, including the execution of software stored on the computer-readable medium/memory. The software, when executed by the cellular baseband processor(s) 1124/application processor(s) 1106, causes the cellular baseband processor(s) 1124/application processor 1106 to perform the various functions described supra. The computer-readable medium/memory may also be used for storing data that is manipulated by the cellular baseband processor(s) 1124/application processor(s) 1106 when executing software. The cellular baseband processor(s) 1124/application processor 1106 may be a component of the UE 350 and may include the at least one memory 360 and/or at least one of the TX processor 368, the RX processor 356, and the controller/processor 359. In one configuration, the apparatus 1104 may be at least one processor chip (modem and/or application) and include just the cellular baseband processor(s) 1124 and/or the application processor(s) 1106, and in another configuration, the apparatus 1104 may be the entire UE (e.g., see UE 350 of FIG. 3) and include the additional modules of the apparatus 1104.

As discussed supra, the LP RRM component 198 is configured to communicate with a serving cell using a first receiver and perform one or more measurements in an RRC connected mode on a LP-RS using a second receiver having a lower power consumption than the first receiver. The LP RRM component 198 may be further configured to perform any of the aspects described in connection with FIGS. 7 and 8 and/or performed by the UE in FIG. 4. The LP RRM component 198 may be within the cellular baseband processor(s) 1124, the application processor(s) 1106, or both the cellular baseband processor(s) 1124 and the application processor(s) 1106. The LP RRM component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1104 may include a variety of components configured for various functions. In one configuration, the apparatus 1104, and in particular the cellular baseband processor 1124 and/or the application processor(s) 1106, includes means for communicating with a serving cell using a first receiver and means for perform one or more measurements in an RRC connected mode on a LP-RS using a second receiver having a lower power consumption than the first receiver. The apparatus 1104, and in particular the cellular baseband processor 1124 and/or the application processor(s) 1106, may also include means for receive a configuration of an offset for at least one threshold associated with the one or more measurements on the LP-RS. The apparatus 1104, and in particular the cellular baseband processor(s) 1124 and/or the application processor(s) 1106, may also include means for determine an offset between the LP-RS measured at the second receiver and a corresponding reference signal measured at the first receiver. The apparatus 1104, and in particular the cellular baseband processor(s) 1124 and/or the application processor 1106, may also include means for receive a measurement object configuration indicating a LP-RS configuration. The apparatus 1104, and in particular the cellular baseband processor(s) 1124 and/or the application processor(s) 1106, may also include means for receive a LP-RS configuration associated with a BWP that does not include an SSB. The apparatus 1104 may further include means to perform any of the aspects described in connection with FIGS. 7 and 8 and/or performed by the UE in FIG. 4. The means may be the LP RRM component 198 of the apparatus 1104 configured to perform the functions recited by the means. As described supra, the apparatus 1104 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 12 is a diagram 1200 illustrating an example of a hardware implementation for a network entity 1202. The network entity 1202 may be a BS, a component of a BS, or may implement BS functionality. The network entity 1202 may include at least one of a CU 1210, a DU 1230, or an RU 1240. For example, depending on the layer functionality handled by the LP RRM signaling component 199, the network entity 1202 may include the CU 1210; both the CU 1210 and the DU 1230; each of the CU 1210, the DU 1230, and the RU 1240; the DU 1230; both the DU 1230 and the RU 1240; or the RU 1240. The CU 1210 may include at least one CU processor 1212. The CU processor 1212 may include on-chip memory 1212′. In some aspects, the CU 1210 may further include additional memory modules 1214 and a communications interface 1218. The CU 1210 communicates with the DU 1230 through a midhaul link, such as an F1 interface. The DU 1230 may include at least one DU processor 1232. The DU processor 1232 may include on-chip memory 1232′. In some aspects, the DU 1230 may further include additional memory modules 1234 and a communications interface 1238. The DU 1230 communicates with the RU 1240 through a fronthaul link. The RU 1240 may include at least one RU processor 1242. The RU processor 1242 may include on-chip memory 1242′. In some aspects, the RU 1240 may further include additional memory modules 1244, one or more transceivers 1246, one or more antennas 1280, and a communications interface 1248. The RU 1240 communicates with the UE 104. The on-chip memory 1212′, 1232′, 1242′ and the additional memory modules 1214, 1234, 1244 may each be considered a computer-readable medium/memory. Each computer-readable medium/memory may be non-transitory. Each of the processors 1212, 1232, 1242 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the LP RRM signaling component 199 is configured to configure a LP-RS configuration for a UE for one or more measurements in an RRC connected mode with a second receiver at the UE having a lower power consumption than a first receiver at the UE and transmit the LP-RS. The LP RRM signaling component 199 may be further configured to perform any of the aspects described in connection with FIGS. 9 and 10 and/or performed by the base station in FIG. 4. The LP RRM signaling component 199 may be within one or more processors of one or more of the CU 1210, DU 1230, and the RU 1240. The LP RRM signaling component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1202 may include a variety of components configured for various functions. In one configuration, the network entity 1202 includes means for configuring a LP-RS configuration for a UE for one or more measurements in an RRC connected mode with a second receiver at the UE having a lower power consumption than a first receiver at the UE and means for transmitting a LP-RS. The network entity 1202, in some aspects, may further include means for transmitting communication to the UE for reception with the first receiver, the communication overlapping in time with the LP-RS. The network entity may further include means to perform any of the aspects described in connection with FIGS. 9 and 10 and/or performed by the base station in FIG. 4. The means may be the LP RRM signaling component 199 of the network entity 1202 configured to perform the functions recited by the means. As described supra, the network entity 1202 may include the TX processor 316, the RX processor 370, and the controller/processor 375. As such, in one configuration, the means may be the TX processor 316, the RX processor 370, and/or the controller/processor 375 configured to perform the functions recited by the means.

In RRC connected states RS measurement may consume UE power and may lead to measurement gaps (e.g., if communication and measurement are performed by a same receiver). For example, if a UE is not capable of performing RRM (or other) measurements using a main receiver on a frequency different from its serving cell frequency at a same time as a data communication, it may implement measurement gaps to measure the RS transmitted via the different frequency than the frequency used for the data communication. A measurement gap, in some aspects, may be a time period during which a UE tunes its operating frequency to the frequency associated with the RS measurement and performs one or more measurements on the reference signals (e.g., for inter-frequency RS measurements). During a measurement gap, a UE may interrupt its regular data Tx/Rx operations. For this reason, implementing measurement gaps may be expensive and have a negative impact on UE throughput.

In some configurations, a UE may be equipped with a second, low-power radio and/or receiver (e.g., the LP-WUR) that utilizes less power than the main (first) receiver and/or radio of the UE. In an example, the LP-WUR may utilize less than 1 mA. In some aspects, the LP-WUR may be configured to receive a low-power wakeup signal (LP-WUS) or a LP-RS. In some aspects, a UE may use a LP-WUR capable of using LP-RS for RS measurements. The LP-WUR may be used to perform inter-frequency RS measurement at the same time as a main radio and/or receiver is used to receive data communications. The use of the LP-WUR may increase data throughput (e.g., by eliminating measurement gaps) and may reduce a power consumption associated with the measurement.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. If a first apparatus receives data from or transmits data to a second apparatus, the data may be received/transmitted directly between the first and second apparatuses, or indirectly between the first and second apparatuses through a set of apparatuses. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE, including: communicating with a serving cell using a first receiver; and performing one or more measurements in an RRC connected mode on a LP-RS using a second receiver having a lower power consumption than the first receiver.

Aspect 2 is the method of aspect 1, further including receiving a configuration of an offset for at least one threshold associated with the one or more measurements on the LP-RS.

Aspect 3 is the method of aspect 1, further including determining an offset between the LP-RS measured at the second receiver and a corresponding reference signal measured at the first receiver.

Aspect 4 is the method of aspect 3, where the corresponding reference signal comprises an SSB configured in a same BWP as the LP-RS.

Aspect 5 is the method of any of aspects 1-4, where communication with the first receiver overlaps in time with the one or more measurements with the second receiver.

Aspect 6 is the method of any of aspects 1-5, where the one or more measurements include an RRM measurement of a serving cell or one or more neighbor cells.

Aspect 7 is the method of aspect 6, where the one or more measurements include an inter-frequency measurement.

Aspect 8 is the method of any of aspects 1-7, further including receive a measurement object configuration indicating a LP-RS configuration.

Aspect 9 is the method of aspect 8, the LP-RS configuration indicates a location in at least one of time or frequency of the LP-RS relative to an SSB.

Aspect 10 is the method of any of aspects 8 and 9, further including performing the one or more measurements on the LP-RS instead of a reference signal measured with the first receiver based on a presence of the LP-RS configuration in the measurement object configuration.

Aspect 11 is the method of any of aspects 1-10, where the one or more measurements include a serving cell measurement.

Aspect 12 is the method of aspect 11, further including receiving a LP-RS configuration associated with a BWP that does not include an SSB, the LP-RS included in at least one of a serving cell measurement object configuration or a BWP specific measurement object configuration.

Aspect 13 is the method of aspect 12, where the LP-RS configuration includes at least one of: a time location of the LP-RS relative to the SSB for a particular frequency, a frequency location of the LP-RS relative to a target frequency, or a measurement offset for the LP-RS relative to an SSB measurement.

Aspect 14 is the method of any of aspects 12 or 13, further including performing the one or more measurements on the LP-RS instead of the SSB based on a presence of the LP-RS configuration in the serving cell measurement object configuration or the BWP specific measurement object configuration.

Aspect 15 is a method of wireless communication at a network node, including: configuring a LP-RS configuration for a UE for one or more measurements in an RRC connected mode with a second receiver at the UE having a lower power consumption than a first receiver at the UE; and transmitting the LP-RS.

Aspect 16 is the method of aspect 15, further including transmitting communication to the UE for reception with the first receiver, the communication overlapping in time with the LP-RS.

Aspect 17 is the method of any of aspects 15 and 16, where the one or more measurements include an RRM measurement of a serving cell or one or more neighbor cells.

Aspect 18 is the method of any of aspects 15-17, where the one or more measurements include an inter-frequency measurement.

Aspect 19 is the method of any of aspects 15-18, where the one or more measurements include a serving cell measurement.

Aspect 20 is the method of any of aspects 15-19, where the LP-RS configuration is associated with a BWP that does not include an SSB, the LP-RS comprised in at least one of a serving cell measurement object configuration or a BWP specific measurement object configuration.

Aspect 21 is the method of aspect 15-20, where the LP-RS configuration includes at least one of: a time location of the LP-RS relative to an SSB for a particular frequency, a frequency location of the LP-RS relative to a target frequency, or a measurement offset for the LP-RS relative to an SSB measurement.

Aspect 22 is an apparatus for wireless communication at a user equipment (UE) comprising at least one memory and at least one processor coupled to the at least one memory and configured to perform a method in accordance with any of aspects 1-14.

Aspect 23 is an apparatus for wireless communication at a user equipment (UE) comprising at least one memory and at least one processor coupled to the at least one memory and, based at least in part on information stored in the at least one memory, the at least one processor, individually or in any combination, is configured to cause the UE to perform a method in accordance with any of aspects 1-14.

Aspect 24 is an apparatus for wireless communication at a user equipment (UE) comprising one or more memories and one or more processors coupled to the one or more memories and, based at least in part on information stored in the at least one or more memories, the one or more processors, individually or in any combination, are configured to cause the UE to perform a method in accordance with any of aspects 1-14.

Aspect 25 is an apparatus for wireless communication, including means for performing a method in accordance with any of aspects 1-14.

Aspect 26 is the apparatus of any of aspects 22-25, further including a first receiver and a second receiver, wherein the second receiver operates using less power than the first receiver.

Aspect 27 is the apparatus of any of aspect 22-25 further including a transceiver coupled to the at least one processor.

Aspect 28 is a non-transitory computer-readable medium including instructions that, when executed by an apparatus, cause the apparatus to perform a method in accordance with any of aspects 1-14.

Aspect 29 is an apparatus for wireless communication at a network node comprising a memory and at least one processor coupled to the memory and configured to perform a method in accordance with any of aspects 15-21.

Aspect 30 is an apparatus for wireless communication at a network node comprising at least one memory and at least one processor coupled to the at least one memory and, based at least in part on information stored in the at least one memory, the at least one processor, individually or in any combination, is configured to cause the network node to perform a method in accordance with any of aspects 15-21.

Aspect 31 is an apparatus for wireless communication at a network node comprising one or more memories and one or more processors coupled to the one or more memories and, based at least in part on information stored in the at least one or more memories, the one or more processors, individually or in any combination, are configured to cause the network node to perform a method in accordance with any of aspects 15-21.

Aspect 32 is an apparatus for wireless communication, including means for performing a method in accordance with any of aspects 15-21.

Aspect 33 is a non-transitory computer-readable medium including instructions that, when executed by an apparatus, cause the apparatus to perform a method in accordance with any of aspects 15-21.

Aspect 34 is the apparatus of any of aspects 29-31, further including at least one transceiver coupled to the at least one processor and configured to transmit communication to the UE for reception with the first receiver.

1. An apparatus for wireless communication at a user equipment (UE), comprising:
at least one memory; and
at least one processor coupled to the at least one memory and, based at least in part on stored information stored in the at least one memory, the at least one processor, individually or in any combination, is configured to cause the UE to:
communicate with a serving cell using a first receiver; and
perform one or more measurements in an RRC connected mode on a low-power reference signal (LP-RS) using a second receiver having a lower power consumption than the first receiver.

2. The apparatus of claim 1, wherein the one or more measurements include a radio resource management (RRM) measurement of the serving cell or one or more neighbor cells.

3. The apparatus of claim 2, wherein the one or more measurements include an inter-frequency measurement.

4. The apparatus of claim 1, wherein the at least one processor is further configured to cause the UE to:
receive a configuration of an offset for at least one threshold associated with the one or more measurements on the LP-RS.

5. The apparatus of claim 1, wherein the at least one processor is further configured to cause the UE to:
determine an offset between the LP-RS measured at the second receiver and a corresponding reference signal measured at the first receiver.

6. The apparatus of claim 5, wherein the corresponding reference signal comprises a synchronization signal block (SSB) configured in a same bandwidth part (BWP) as the LP-RS.

7. The apparatus of claim 1, wherein communication with the first receiver overlaps in time with the one or more measurements with the second receiver.

8. The apparatus of claim 1, wherein the at least one processor is configured to cause the UE to:
receive a measurement object configuration indicating a LP-RS configuration.

9. The apparatus of claim 8, wherein the LP-RS configuration indicates a location in at least one of time or frequency of the LP-RS relative to a synchronization signal block (SSB).

10. The apparatus of claim 8, wherein the at least one processor is configured to cause the UE to perform the one or more measurements on the LP-RS instead of a reference signal measured with the first receiver based on a presence of the LP-RS configuration in the measurement object configuration.

11. The apparatus of claim 1, wherein the one or more measurements include a serving cell measurement.

12. The apparatus of claim 11, wherein the at least one processor is configured to cause the UE to:
receive a LP-RS configuration associated with a bandwidth part (BWP) that does not include a synchronization signal block (SSB), the LP-RS comprised in at least one of a serving cell measurement object configuration or a BWP specific measurement object configuration.

13. The apparatus of claim 12, wherein the LP-RS configuration includes at least one of:
a time location of the LP-RS relative to the SSB for a particular frequency,
a frequency location of the LP-RS relative to a target frequency, or
a measurement offset for the LP-RS relative to an SSB measurement.

14. The apparatus of claim 12, wherein the at least one processor is configured to cause the UE to perform the one or more measurements on the LP-RS instead of the SSB based on a presence of the LP-RS configuration in the serving cell measurement object configuration or the BWP specific measurement object configuration.

15. The apparatus of claim 1, further comprising:
the first receiver coupled to the at least one processor; and
the second receiver coupled to the at least one processor.

16. A method of wireless communication at a user equipment (UE), comprising:
communicating with a serving cell using a first receiver; and
performing one or more measurements in an RRC connected mode on a low-power reference signal (LP-RS) using a second receiver having a lower power consumption than the first receiver.

17. The method of claim 16, further including:
receiving a configuration of an offset for at least one threshold associated with the one or more measurements on the LP-RS.

18. The method of claim 16, further including:
determining an offset between the LP-RS measured at the second receiver and a corresponding reference signal measured at the first receiver.

19. The method of claim 18, wherein the corresponding reference signal comprises a synchronization signal block (SSB) configured in a same bandwidth part (BWP) as the LP-RS.

20-21. (canceled)

22. An apparatus for wireless communication at a network node, comprising:
at least one memory; and
at least one processor coupled to the at least one memory and, based at least in part on stored information stored in the at least one memory, the at least one processor, individually or in any combination, is configured to cause the network node to:
provide a low-power reference signal (LP-RS) configuration for a user equipment (UE) for one or more measurements in an RRC connected mode with a second receiver at the UE having a lower power consumption than a first receiver at the UE; and
transmit a LP-RS based on the LP-RS configuration.

23-30. (canceled)
